(19) United States
(12) Patent Application Publication
(10) Pub. No.: US 2009/0108989 A1
(43) Pub. Date: Apr. 30, 2009

(54) Personal access arrangement for a vehicle

(75) Inventor: Peter Sinclair, New South Wales (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KEYLESS LIFESTYLES PTY LTD, St. Ives, New South Wales (AU)

(21) Appl. No.: 11/815,944

(22) PCT Filed: Feb. 10, 2006
(86) PCT No.: PCT/AU2006/000175

§ 371 Date: Mar. 12, 2008

(30) Foreign Application Priority Data
Feb. 11, 2005 (AU) 2005900656

(51) Int. Cl. G05B 19/00; B60R 25/00

(52) U.S. Cl. 340/5.62; 307/10.2; 307/10.3

(57) ABSTRACT

Disclosed is a system (1100) to permit access and operation of a machine (100). The machine has a ignition switch arrangement (1152) actuable by at least user manipulation thereof and arranged to enable operation of the machine and at least one immobilizer arrangement (1150) connected with the ignition switch arrangement and configured to selectively inhibit or permit operation of the machine via the switch arrangement. The system comprises a proximity detection arrangement (1110, 1120) associable with the machine and adapted for detection and reading of at least one proximity identification device (1132) carried or worn by a user of the machine. A control arrangement (1122) is responsive to detection by the proximity detection arrangement of a valid device to thereby disarm the immobilizer arrangement. The proximity detection arrangement is at least operationally independent of the ignition switch arrangement and any key actuator (1400) thereof. Desirably the proximity detection arrangement includes a flat flexible antenna having a coil printed as a circuit upon a substrate. The antenna may be affixed to a window of the machine to permit scanning of the identification deice from an exterior thereof and to thereby control access to the machine to permit the operation thereof.

### FIELD OF THE INVENTION

The present invention relates generally to systems for secure access and, in particular, describes an arrangement which affords convenience of use, particularly for secure access to a motor vehicle.

### BACKGROUND

Secure access to a structure such as a house or office complex, or to apparatus such as a motor vehicle, has traditionally been provided through a physical lock and key mechanism. Where an individual may, through the course of their day require access to a large number of locked premises and a (number of) motor vehicle(s), the individual will typically carry a number of physical keys which are required to open the corresponding mechanical locks that are used to secure these arrangements.

Over recent years, there has been a substantial growth in access systems that make use of electronic technology in order to obviate the need for traditional lock and key mechanisms. Such access arrangements now pervade industry. In the early 1990's, magnetic swipe cards were commonly used to provide individuals with access to buildings and other places of work. A user carried a card upon which was magnetically encoded a particular code. When scanned by a scanning device adjacent to the door or other access point, the code is read from the card and, if the code existed within a list of authorised access codes, the door or entry way was unlocked and access is permitted. Magnetic stripe systems afford the advantage that cards may be readily produced by a local secure authority (for example, building management). Such issuing, programming and reprogramming of cards occurs in many environments, one good example is in major hotels where upon arrival, a hotel guest may be provided with a swipe card encoded for the particular room in which they are to stay.

Australian Patent No. 668325, having a priority date of 25 Mar. 1994 disclosed a personal access arrangement in which an access disc, such as a “DS-1990-R3 battery key” (manufactured by Dallas Semiconductors Inc. of Texas, USA) was affixed to a watch strap or jewellery ring to afford secure access to a building. The battery key required physical and electrical contact between the battery key and the reading arrangement to permit a reading of a code from the battery key. Subject to a valid code being read, access could then be obtained in a manner corresponding to that of the magnetic stripe arrangement.

In the mid 1990's, proximity cards started to replace magnetic swipe cards in providing secure access in industry and commerce. Proximity cards now pervade industry and typically include an integrated circuit device which carries the necessary code. A control module or scanner adjacent to the door way or access point includes an antenna which emits a signal which is received by the card and which initiates a response from the card including the encoded value. Upon detecting the encoded value, the control system for the proximity arrangement works in a manner corresponding to that of the magnetic stripe arrangement and the battery key system. A variety of proximity cards exist. Some include surface acoustic wave (SAW) devices which are entirely passive and which, when irradiated from the scanning antenna, reflect energy that is encoded by the specific code. Others make use of Weigand loops in the card. Some devices make use of the radiated energy to power up an electronic circuit within the integrated circuit device which then enables an integral radio frequency transmitter to transmit the specific encoded value. In most instances, the proximity device is provided on a card that is typically credit-card size (approximately 85 mm×54 mm×2 mm).

One manufacturer of proximity access devices is HID Corporation of the USA which provides a range of devices including the “Pocket Tag” which is a small card type device configured to be carried in the pocket of the user or upon a key ring also carried by the user (see http://www.hidcorp.com/products/wiegandproducts/pocketagtag.html).

Access cards of the magnetic stripe or proximity types are typically worn either attached to a strap about the neck of the user or clipped to the belt or pocket of the user. Due to the varying types and placement of the scanners and the like, it is typically required for the user to handle the card to move the card into proximity with the scanning device. A further device is the MicroProx®Tag (HID Corporation) which is an adhesive backed proximity tag configured to be adhered to a card, mobile telephones and the like. Such still requires the user to pass the card or telephone across the scanner.

Whilst magnetic stripe and the proximity scanning access devices are widely used for access control to buildings in industrial and commercial environments, such arrangements have not been taken up in domestic or small volume situations. This is due, in part, to the relative significant cost of installation, inconvenience surrounding their general use, and the availability of cards. In this regard, in an office complex where perhaps 1000 persons require 24 hour 7 day access it is much simpler to provide each user with a specifically encoded card so that access control and access monitoring can be performed. In the domestic environment, such volumes and access monitoring are not required and hence it has typically been easier for individuals to, where the need requires, have a further key cut to enable access to their home or motor vehicle.

Australian Patent Publication No. 2004100122 A4 disclosed a system by which a passive RFID transponder tag could be used to provide for personal secure access to a motor vehicle. That system presented a simple control arrangement permitting tag reading and consequential operation of a central locking system of the motor vehicle.

It is an object of the present invention to substantially overcome, or at least ameliorate, one or more problems associated with known arrangements.

### SUMMARY

In accordance with one aspect of the present disclosure there is provided a system in which a one proximity identification device able to be worn or carried by a user in which the device is configured to permit operational access to a facility or a machine and to at least disarm an immobilization function associated with the facility or machine.

In accordance with another aspect of the present disclosure there is provided a user operable machine comprising:

a switch arrangement actuable by at least user manipulation thereof and arranged to enable operation of said machine;

at least one immobiliser arrangement connected with said switch arrangement and configured to selectively inhibit or permit operation of said machine via said switch arrangement; and

a proximity detection arrangement associated with said machine and adapted for detection and reading of at least one proximity identification device carried or worn by a user of said machine, said proximity detection arrangement being independent of said switch arrangement and any actuator thereof; whereby

reading of a validly registered identification device by said proximity detection arrangement provides for a disarming of said immobilizer arrangement to thereby permit operation of said machine.

In accordance with another aspect of the present disclosure there is provided an access system for a motor vehicle, the system comprising:

a substantially flat antenna device arranged to affix to a window of the motor vehicle; and

a controller locatable within the motor vehicle and coupled to each of the flat antenna and a locking system associated with entry to a cabin of the motor vehicle, the controller including a proximity detection arrangement configured, in association with the flat antenna, to detect a proximity tag having a coded value when such is brought into proximity with the flat antenna, and to compare the detected coded value with a retained list of such values to thereby enable or disable operation of the locking system.

Typically, the controller comprises programming mode of operation in which a programming proximity device is detected when the programming device is brought into proximity with the flat antenna, the programming proximity device causing the controller to operate in a programming mode to thereby validate a further proximity device to enable access to the motor vehicle via the flat antenna. The controller may have a further antenna formed therein and which is arranged to detect the programming proximity device.

Typically, the first antenna has a winding loop formed upon a flexible substrate and which may be adhered to a fixed window of the motor vehicle. Typically, the flat antenna is sized to approximate that of a registration label for the motor vehicle. The winding loop is preferably formed as a substantially flat printed circuit upon the substrate.

Other aspects of the invention are also disclosed.

### BRIEF DESCRIPTION OF THE DRAWINGS

At least one embodiment of the present invention will now be described with reference to the drawings in which:

FIG. 1 is a view of a motor vehicle including a passive RFID access system;

FIG. 2 illustrates a hand of a user where the proximity access device is worn either on a watch strap or on a jewellery ring;

FIG. 3 is a schematic illustration of an access system for the motor vehicle of FIG. 1;

FIG. 4 is a schematic block diagram representation of the proximity reader unit of FIG. 3;

FIG. 5 is a detailed block diagram representation of the access system of FIG. 3;

FIG. 6 is a flowchart of procedures for validating a master tag on installation of the system of FIG. 3 to a motor vehicle;

FIG. 7 is a flowchart of procedures for validating further tags of the system of FIG. 3;

FIG. 8 is a flowchart of a main operation program of the system of FIG. 3;

FIG. 9 is a block diagram representation, similar to FIG. 4, but of an alternate access system;

FIG. 10 is a flowchart of a main operation program form the access system of FIG. 9;

FIG. 11 is a schematic illustration of an another access system for the motor vehicle of FIG. 1;

FIG. 12 is a transverse sectional view of the flat antenna seen in FIG. 11;

FIG. 13 is an illustration of an antenna for use in the system of FIG. 11;

FIG. 14 is a prior art motor vehicle key;

FIG. 15 is a plan view of a further arrangement permitting remote access and immobilization control of a motor vehicle;

FIG. 16 is an elevation view of part of the arrangement of FIG. 15; and

FIG. 17 shows a variation on the arrangement of FIGS. 15 and 16.

### DETAILED DESCRIPTION INCLUDING BEST MODE

FIG. 2 shows a forearm and hand 200 of a user upon which are worn a watch 210 having a watch strap 212, and a jewellery ring 220. Attached to the watch strap 212 is a passive proximity tag device 214. A similar but differently shaped proximity tag device 222 is affixed to a jewellery ring 220. The proximity devices 214, 222 can be affixed to the watch strap 212 or ring 220 using an adhesive such as epoxy resin, or via a stud fastener. Other methods of affixing may be used.

With such an arrangement, as described in Australian Patent Publication No. 2004100122 A4, all that is required is for the watch strap 212 or ring 220 to pass within a detection distance of a complementary proximity detector, usually 5 to 20 centimetres, in order for the proximity detector to become operative which, in that publication, resulted in the actuation of a motor vehicle central locking system.

It will be appreciated that, in FIG. 2, the user 200 need only have one of the devices 214 or 220 to obtain access to the vehicle or other structure, unless the devices 214 or 220 were of different mode of operation and therefore dependent on a particular type of proximity detector.

Although, not illustrated, placement of the proximity devices 214, 222 may be upon other apparatus adapted to be worn at or near the hand. Such for example could be a bracelet. For optimal and reliable operation, the tag 214, 220 should be affixed to a non-metallic backing to prevent unwanted electromagnetic reflections upon scanning. In this regard, the watch strap 212 may be leather or a synthetic (eg. nylon) mesh. A metal bracelet-type watch strap may be used provided the tag device is mounted upon a non-reflective (eg. leather) insert section, or upon a metal section of relatively low density sufficient to permit magnetic coupling between the tag and a detector-reader unit. Similarly, the jewellery ring 220 is preferably non-metallic. Further a “watch” strap is not essential, as any non-metallic strap about the wrist may be suitable.

A variety of proximity tag devices may be used in the arrangement of FIG. 2. One such device is the MicroProx® tag manufactured by HID Corporation. Such however may be considered oversized or bulky for forearm use. One tag device well suited to these applications is a 12 mm disc tag from Sokymat or a ECO-line Low Frequency 12 mm Wedge Transponder manufactured by Texas Instruments of the USA. Such has dimensions 12 mm×6 mm×3 mm and has a typical reading range of less than 20 cm. Both these devices are waterproof and thereby suitable for everyday wear.

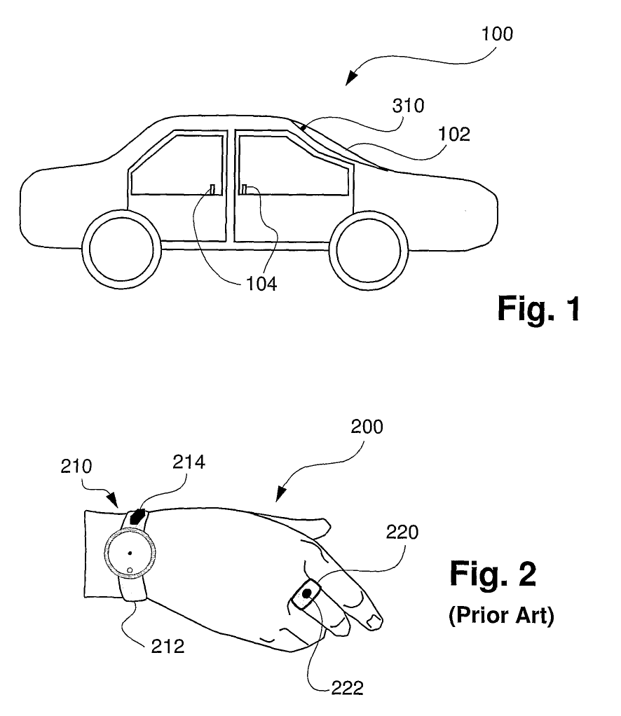

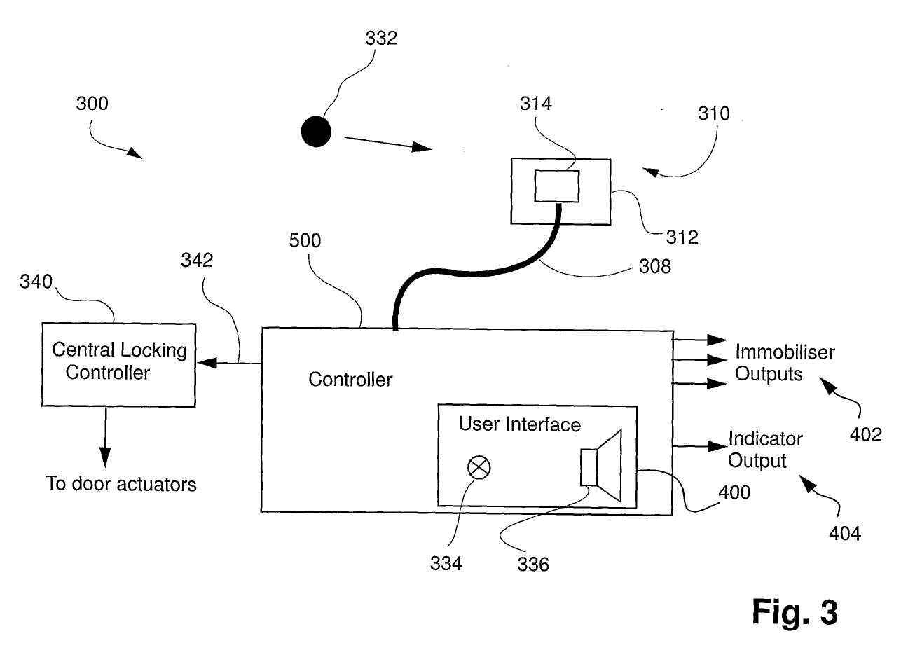

The arrangements of FIG. 2 can be used to provide access in to any building or other structure which incorporates a complementary access arrangement. An example of such according to the present disclosure is shown in FIG. 1 where a motor vehicle 100 incorporates, attached to its windscreen 102, an RFID proximity detector unit 310. As seen in FIG. 3, an access control system 300 is illustrated and which is configured within the motor vehicle 100 to provide access from the exterior of the motor vehicle 100 to the cabin of the motor vehicle 100, whilst also operating to perform various immobilizer functions associated with many motor vehicles manufactured over the past 5 years or so.

The system of FIG. 3 is configured for operation using a proximity tag device 322 which may be active or passive, and which may be traditionally carried or worn in the fashion of FIG. 2.

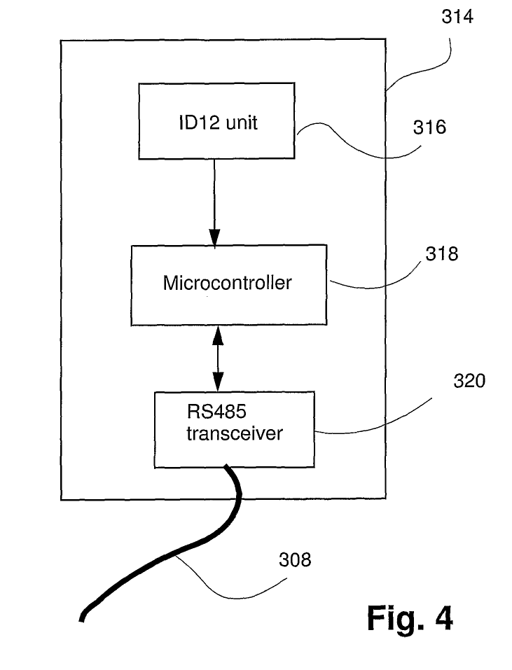

The system 300 has a controller module 500 to which the proximity detector 310 connects via a coupling cable 308. The proximity detector 310 must complement the technology of the proximity tag 322. The proximity detector 310 is formed of casing 312, enclosing an RFID detector module 314. Further detail of the module 314 is seen in FIG. 4, which for a passive tag implementation includes an ID12 RFID unit 316 manufactured by Innovated Devices. The ID12 RFID unit is a short-range proximity reader which, with associated electronic components including an antenna (not illustrated) operates to detect a proximal presence of a complementary RFID device, such as the device 332 of FIG. 3, and to read a unique number encoded thereon. The ID12 unit 316 couples to a microcontroller 318 that manages communication transfer of ID codes to the controller 500, via an RS485 transceiver 320.

The controller 500 includes a user interface 400 incorporating a light emitting diode (LED) 334 and a buzzer 336 for providing visual and audible feedback to a user regarding operation of the system 300. The controller has an output 342 that couples to a central locking controller 340 of the motor vehicle 100 to cause operation of door actuators 103 (FIG. 1) to thus lock and unlock the doors. The controller 500 further includes a number of immobilizer outputs 402 to implement immobilization of the motor vehicle 100 and an indicator output 404 that affords visual feedback of operation of the system 300 from outside of the motor vehicle 100. The immobilizer outputs 402 couple to immobiliser arrangements connected in the vehicle 100 typically in series with normal operational enabling circuits (such as ignition, starter, fuel pump).

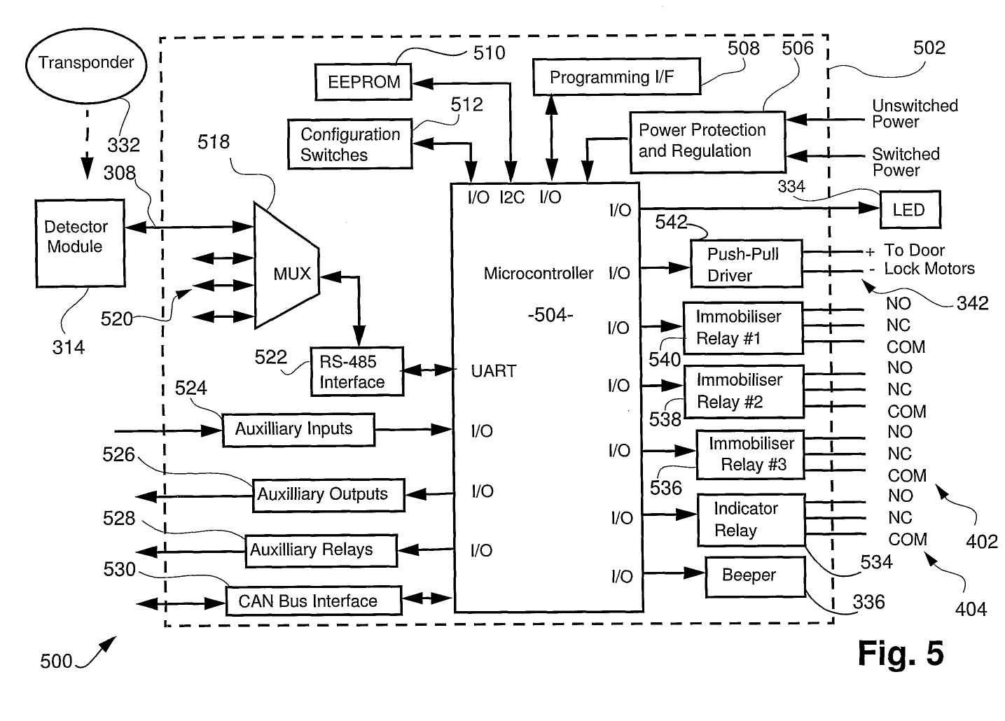

FIG. 5 shows further detail of the controller 500 which incorporates an electronics circuit 502, which interfaces with at least one, and up to four detector units 310 and the corresponding detector module 314. In the vehicular deployment, one detector unit 310 is typically mounted on the inside of the vehicle windscreen 102 and is used for access control at the driver's door. Other detector units 310 may be positioned about the vehicle at convenient locations where access may typically be required. These may include near the boot or luggage compartment or at the passenger side doors. The detector units 310 must be positioned so that magnetic coupling with RFID tags 332 may be performed and, as such, cannot be mounted behind metal bodywork. Positioning behind glass will permit magnetic coupling, as will positioning behind plastics materials, such as found in bumper bars, and external mirror surrounds. The controller 500 is installed in a protected location within the passenger cabin, typically behind the dashboard. The system 300 may further be adapted for non-vehicular applications such as residential premises access control or hotel room access control.

The detector units 310 couple to the controller 500 via a multiplexer 518 which connects to an RS485 interface 522 complementing the operation of the transceiver 320 found within the detector unit 310 (see FIG. 4). This permits data to be communicated with a microcontroller 504 which manages operation of the controller 500.

The microcontroller 504 has associated firmware, including one or more controlling programs, which are generally stored in an integrally formed programmable read-only-memory (PROM), and provides for overall control of the system 300, including processing of transponder detection, lock control, immobilizer control, user feedback via the LED 334, buzzer 336 and vehicle indicators, transponder learning, self test and other functions of the system 500. The microcontroller 504 is preferably a single-chip embedded 8 or 16 bit controller, such as a Texas Instruments MSP430 series device which has on-chip volatile random access memory (RAM) and a variety of input and output ports configurable under program or hardware control to perform a variety of tasks.

The light emitting diode (LED) 334 is typically mounted remotely from an enclosure of the control circuit 502, and receives an output of the microcontroller 504 to provide visual feedback to the user regarding locking and immobilizer state, learning operations, error conditions and the like, to be described.

A further output of the microcontroller 504 supplies a push-pull driver 542 which provides a facility to supply a circuit with either power polarity via a two-wire connection. In the preferred implementation this is used to allow a door lock motor to be driven in either direction to facilitate locking and unlocking of motor vehicle doors. Thus the push-pull driver 542 supplies the output 342 for central locking operation.

FIG. 5 also illustrates four relay outputs each driven by the microcontroller 504. Each relay output has three terminals, being common (COM), normally open (NO) and normally closed (NC). A first immobiliser relay 540 is controlled by the microcontroller 504 to provide an uncommitted voltage-free changeover contact for a motor vehicle immobilizer function. Second and third immobiliser relays 538 and 536 may be optionally used to provide a further uncommitted voltage-free changeover contacts for additional immobilizer functions. An indicator relay 534 similarly operates to provide an uncommitted voltage-free changeover contact for connection to the motor vehicle indicator emergency flasher circuit, for user visual feedback functions. In an alternate implementation (not illustrated), a horn relay may also be used to provide an uncommitted voltage-free changeover contact for connection to the motor vehicle horn activation circuit, for user audible feedback functions external to the vehicle.

The control circuit 502 also includes auxiliary inputs 524, for sensing contact closures to ground, and auxiliary outputs 526 having open collector NPN transistor to ground style outputs for controlling low current devices, may be optionally included. Auxiliary low current relays 528, controlled by the microcontroller 504, may be optionally provided to support uncommitted voltage-free changeover contact for auxiliary control functions. The auxiliary inputs 524, outputs 526 and relays 528 are optional and may be used to interconnect the controller 500 functionally for the performing of alarm functions associated with unauthorized access to, tampering with or movement of the motor vehicle 100.

A CAN-Bus interface 530 may be optionally included to supplement functionality of the controller 500 thus permitting use of the control circuits 502 in more exotic (eg. predominantly European as of the filing date) motor vehicles who utilize such a bus for motor vehicle management. The bus would for example be used to drive the door actuators and immobilizer functions thus obviating a need to connect the relays 534-542 in some implementations. CAN-Bus offers a simple two-wire differential serial bus system suited for operation in noisy electrical environments with a high level of data integrity.

The beeper 336 may be mounted inside the enclosure of the control circuit 502 to provide audible feedback to the user regarding locking and immobilizer state, learning operations, error conditions, thereby supplementing operation of the LED 544.

A power protection and regulation unit 506 is configured to provide conditioned power to the microcontroller 504 and other circuitry of the system 500. Desirably the unit is rated for 12V automotive electrical system operation, and includes load dump, polarity reversal and transient protection. Configuration switches 512 in the form of four DIP switches are desirably provided for configuration of the control circuit 502 during installation.

An electrically erasable programmable read-only-memory (EEPROM) 510 is provided and connected to the microcontroller 504 for storing learned transponder codes and configuration parameters of the system 500. The EEPROM 510 may provide a number of storage capacity options, by the fitting of an appropriate device. For example, a 512 byte EEPROM, organized as 8-bit bytes or 16-bit words, will provide sufficient capacity for dual redundant storage of 30 transponder codes, plus unit serial number and configuration information. EEPROM capacities of at least 8 Kbytes can provide sufficient capacity for dual redundant storage of 500 transponder codes.

A programming interface 508 is provided for in-system programming of the microcontroller 504 during manufacture. The interface 508 may be formed as a flying lead cable arranged for connection to a portable (personal) computer for in-field upgrading of software of the controller 500, such software generally being stored in the EEPROM 510.

Many modern motor vehicles include immobiliser arrangements with the immobilizing function being disabled (to enable ordinary use of the vehicle) generally by either disarming an alarm system associated with the vehicle, or by inserting the correct key into the ignition. Such arrangements are problematic. With the alarm implementation, once the alarm is disabled the vehicle may then be started. This may even occur without the need for a proper key, for example by “hot-wiring” the car. Steering locks are also easily avoided and many vehicles are stolen in this fashion. Such still necessitates the authorized user of the vehicle to carry a traditional key or like device.

With integrated immobiliser arrangements, the (usually mechanical) key has integrated therewith some device which is coded and necessary in addition to the key in order to disable any immobiliser function. In some implementations, such a device is a wired circuit in the handle of the key which electrically couples to electrodes at the ignition into which the key is inserted. In other implementations, such may be an RFID proximity device, a reader for proximity detection being activated when the key is inserted into the ignition. Both these arrangements necessitate the user to carry upon themselves the often bulky key. Further, such keys are expensive (eg. $250) to replace if lost, or if additional keys are required. They simply cannot be cut from a blank at a local hardware store.

The arrangement of FIGS. 3, 4 and 5 has been developed to address these problems and to effectively obviate the need for the user to carry the bulky key. This is achieved by one or more of the immobiliser relays 536-540 being connected to immobilise the vehicle in addition to any immobiliser that may already be fitted to the vehicle. As such the system of FIGS. 3-5 may be used in vehicles having sophisticated immobiliser functions and/or alarms, and also in those without any such arrangements.

The relays 536-540 may accordingly be connected to any system of the vehicle that will result in an immobilization of the vehicle. Such may include the feed from the ignition switch, ECU circuits, starter motor, or fuel pump, to name but a few. Connection to the fuel pump can be used to stop operation of the vehicle once such has been started, this feature being desirably linked to alarm implementations. Importantly, according to the present disclosure, since the desirably transponder tag 332 is worn upon the user (FIG. 2), the system 300 may thus be configured to ensure immobilization when the tag is not proximate, at least for a determinable period. Further, the disjunction between the physical key and the tag 322 in the present disclosure requires special handling of immobiliser functions implemented by the controller 500 in order to ensure safe vehicular operation, desirably according to established standards, such as Australian Standard AS 4601. This is discussed below where any further reference to an immobiliser operation, unless otherwise qualified, is to be interpreted as an operation performed by the controller 500 and not by any immobiliser integrated or otherwise formed separately within the vehicle. Further, in the system 300, the proximity detection arrangement is physically and operationally independent of the motor vehicle key and the ignition switch by which the vehicle may be started. This independence provides utility by affording access and immobilization functions that do not require the key or the use thereof, whilst still retaining the need of the key for vehicle operation.

Operation of the system 300 is performed under control of a controlling program stored as code within the PROM of the microcontroller 504, possibly supplemented by code stored in the EEPROM 510. The program includes code enabling the microcontroller 504 to time a range of time periods useful to achieve various functional responses by the system 300. Those time periods may be varied according to the particular implementation and the periods described below are only to be considered exemplary.

Installation of the system 300 involves locating the detector units 310 and the controller 500 as described above and forming appropriate connections to existing circuits of the vehicle 100. The LED 334 should be positioned where such can be easily seen by the driver when seated.

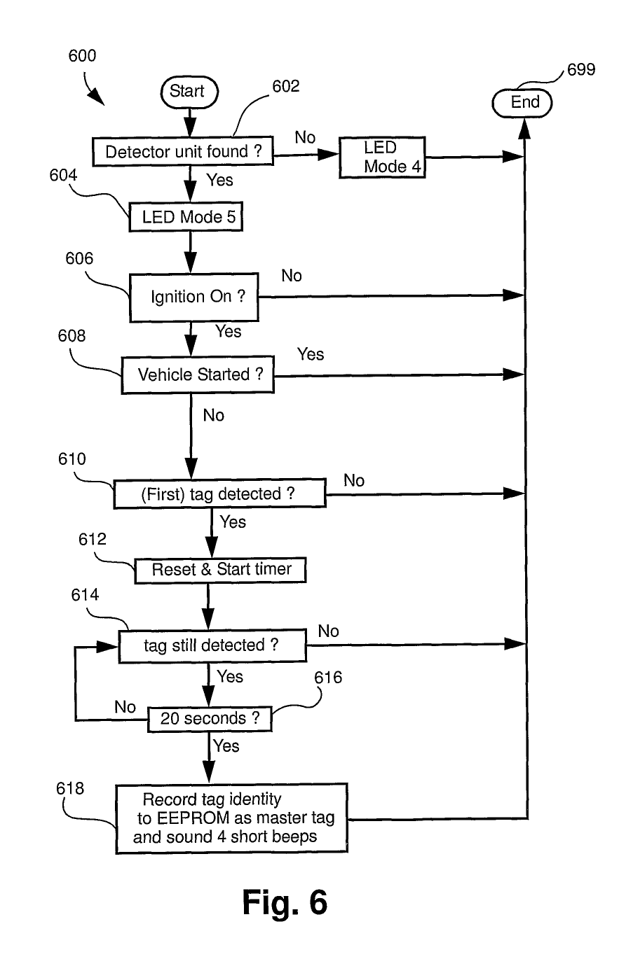

As seen in the flowchart 600 of FIG. 6, when the system 300 is initially powered, the control circuit 502 operates and energizes the detector unit 310. Initially the LED 334 will flash 1 second on and 1 second off (step 604) indicating that the detector unit 310 is active and operating, but that no tags are yet registered. At this stage, a “master” tag is registered in the following fashion. Whilst seated in the vehicle, the ignition is switched on (step 606) using the traditional key, but the vehicle not started (step 608). A tag designated as the “master” tag is brought near the detector unit 310 and held proximate, at step 610. Whilst being held, a series of single and double beeps are sounded from the beeper 336 are heard and after a period of 20 seconds(steps 612, 614, 616), a sequence of beeps are sounded that confirms the master tag has been read properly. With this reading, the microcontroller 504 stores the ID number of the master tag in the EEPROM 510. The ignition is then switched off.

The LED 334 has a number of operational modes, as controlled by the program executing within the microcontroller 504, as indicated in Table 1 below:

TABLE 1

| Mode | LED Indicator | Meaning |
|---|---|---|
| 1 | Off | Immobiliser is not active (ie, |
| | | disarmed) and ignition is on |
| 2 | Flashing slowly (2 second | Immobiliser is active (ie. armed) |
| | off period then a brief | |
| | flash) | |
| 3 | Flashing rapidly | Immobiliser is not active (ie. |
| | | disarmed) and is waiting for the |
| | | ignition to be switched on and the |
| | | vehicle started |
| 4 | On (steady) | Controller 500 has not located a |
| | | detector unit 310 |
| 5 | Flashing (1 second on, 1 | Controller has found and initialized |
| | second off) | one or more detector units 310, |
| | | but no tags are yet registered |

At this stage, operation of the system 300 may be confirmed by exiting the vehicle 100 with the master tag in possession, and locking and unlocking the vehicle by bringing a tag within proximity of the detector unit 310. When locked, the LED 334 will flash in Mode 2. As the doors lock and unlock, the indicator lights are activated briefly via the relay 534. When unlocked, the immobiliser functions are deactivated (disarmed) for a period of two (2) minutes, which is generally sufficient for the driver to enter the vehicle and start the ignition. During this period, the LED 334 flashes in Mode 3. Once the ignition is started, the immobiliser functions are disarmed and the LED 334 reverts to Mode 1. This continues until such time as the ignition is turned off, as detected at the “switched power” input of the power circuit 506, when the LED 334 reverts to Mode 3.

Immobiliser operation may be tested by unlocking the vehicle, waiting two minutes, and then attempting to start the vehicle using the key. If the vehicle is not started within two minutes of being unlocked, the immobiliser functions re-arm to prevent starting. After this two minute period, the immobiliser functions may be disarmed by again bringing a registered tag into proximity of the detector unit 310 twice. A first proximate movement operates to lock the vehicle (Mode 2), and a second proximate movement is used to unlock the vehicle and deactivate the immobiliser functions for another 2 minutes (Mode 3). Alternatively the ignition can be turned on and a registered tag brought to the reader which will deactivate the immobiliser With a standard implementation, up to 30 transponder tags may be registered for operation within one system 300. The master tag, registered during installation is required for registering new tags and for deregistering tags.

Registration of a new tag may be performed as follows. The user is seated within the vehicle and the doors are locked using a valid (eg. the master) tag. The ignition is turned on, but the vehicle engine not started. The master tag is held near the primary detector unit 310 (ie. at the windscreen 102) for a period of 5 seconds upon which a short beep is emitted from the controller 500 via the beeper 336. The master tag is removed and the new tag to be registered is held proximate to the primary detector unit 310 for a period of 5 seconds. After this time, two short beeps are sounded from the controller 500. The new tag is removed and the master tag is again held near the detector unit 310 for another 5 seconds, whereupon 4 short beeps are sounded from the controller 500 confirming that the identity of the new tag has been read and stored in the memory of the controller 500. Where a long beep is sounded at any of these steps, and error has occurred. The ignition should be switched off and the procedure recommenced. Importantly, and unlike traditional keys or similar locking device, one tag may be registered for operation with multiple vehicles, allowing one tag to operate a fleet of vehicles.

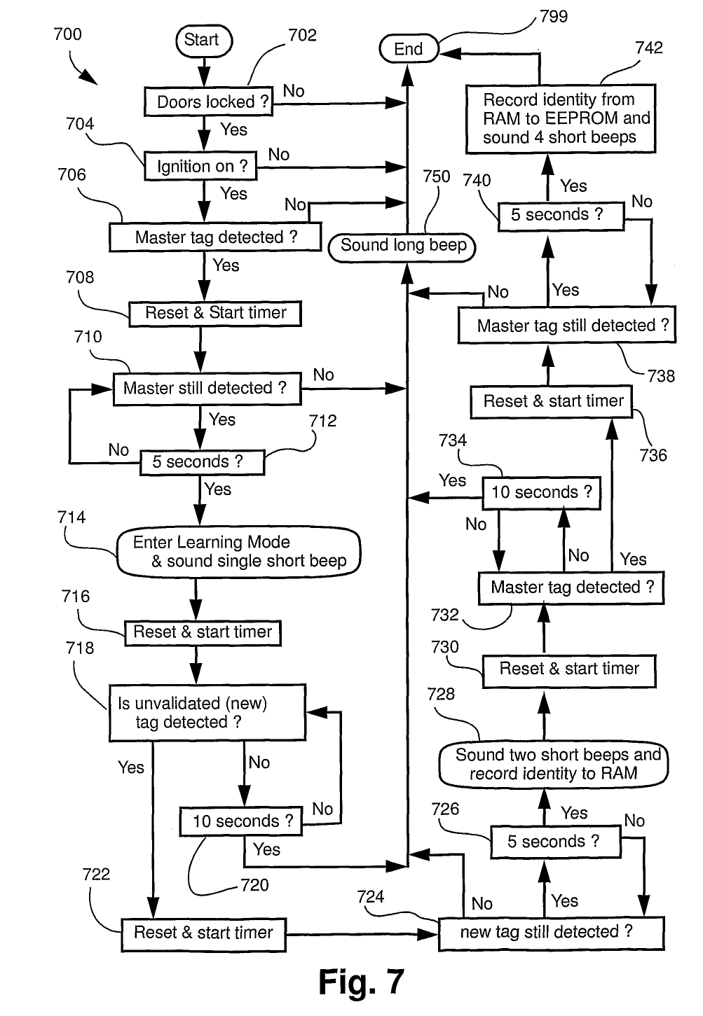

A procedure 700 for learning transponder identities may be implemented as a program recorded in the PROM of the microcontroller 504 and operable as illustrated in FIG. 7. The procedure 700 operates using multiple transponder/tag detections using the detector unit 310 which, due to its placement on the motor vehicle windscreen is readily accessible to an operator. The procedure 700 has a start point and tests at step 702 if the doors are locked and then tests whether the vehicle ignition is on in step 704. If either of these tests fail, the procedure 700 ends at step 799, with no result. If the ignition is on, step 706 tests for the presence of the master transponder tag. If no such tag is detected the procedure also ends at step 799. If, at step 706 the master tag is detected, so as to distinguish normal operation from a transponder programming function, a test is performed to determine of the detected master tag is continuously detected for a predetermined period (eg. 5 seconds). At step 708 a timer, for example implemented by a sub-program within the microcontroller 504, is reset and started. Step 710 then checks if the master tag remains detected. If not, the procedure again ends at step 799, but via step 750 with the sounding of a long beep from the beeper 334. If so, step 712 checks if the timer has timed 5 seconds. If not, control returns to step 710 to again check for the presence of the master tag. When the master tag is continuously detected for the 5 second period, step 712 passes control to step 714 where the program enters the “transponder learning mode”, which may be indicated to the user by sounding of the single short beep from the beeper 532.

Once in the “learning mode” at step 716, the timer is reset and started. The new (invalidated) transponder, whose identity is to be learned, is brought within range of the detector unit 310 within a predetermined period, such as 10 seconds, of the entry to the learning mode. This is implemented by step 718 checking if the new tag is detected. If not, step 720 checks if the timer has timed 10 seconds. If so, and the new tag has not been detected, the procedure ends via step 750. If the new tag is detected within the 10 second period, step 722 follows where the timer is again reset and started.

Step 724 follows to check if the new tag is still detected by the system 500. If not, the procedure again ends via step 750. Where the new tag is detected for a period of 5 seconds as timed by the timer at step 726, step 728 follows where the system 500 provisionally learns the identity of the new tag by reading the identity from the detector unit 310 and recording the same in the RAM of the microcontroller 504. The beeper 334 is sounded for two short beeps to indicate proper reading of the new transponder identity where such is detected continually for the predefined period of 5 seconds.

Permanent learning of the provisionally learned transponder identity is then confirmed. The timer is again reset and started at step 730, whereby steps 732 and 734 check that, within a further predefined period (eg. 10 seconds) of step 728, the master transponder tag originally used to initiate the learning process is again sensed. This step may alternatively be instituted by timing a period after the new tag is removed from proximity to the detector unit 310 after step 728. When the master tag transponder is detected at step 732, the tinier is again reset and started and steps 738 and 740 check that such remains within range of the access control antenna 550 for a continuous predetermined period (eg. 5 seconds). When this occurs, step 742 follows to record the new transponder identity from the RAM to the EEPROM 510. An indication by the beeper 532 of four short beeps indicates to the user the successful completion of the learning procedure 700 which ends at step 799.

If any of the prescribed timing parameters of the procedure 700 are not satisfied, the system 500 shall exit transponder learning mode via step 750 without permanently saving the provisionally learned transponder identity in the EEPROM 510.

Further, whilst not illustrated in FIGS. 6 and 7, turning off the ignition ceases the process being performed.

Where a tag is lost, the identity of such can be detected from the memory of the controller 500. The following procedure operates to delete all tag identities excepting that of the master tag. This necessitates re-validating those other (non-master) tag desired to be used with the vehicle. Detection of tag identities is performed by a program that operates as follows. The user is seated within the vehicle with the doors locked and the master tag in possession. The ignition is turned on, but the vehicle motor not started. The master tag is then held near the primary detector unit 310 for a period of 20 seconds. During that period, other tag identities are deleted and the following audible indications are sounded: 1 beep after 5 seconds, 2 beeps after another 10 seconds, and 4 beeps after another 5 seconds, thereby completing the 20 second interval. All tag identities required to be re-validated are then registered according to the process of FIG. 7.

Because of its importance in system operation, when not being used the master tag should be securely stored by the owner of the vehicle.

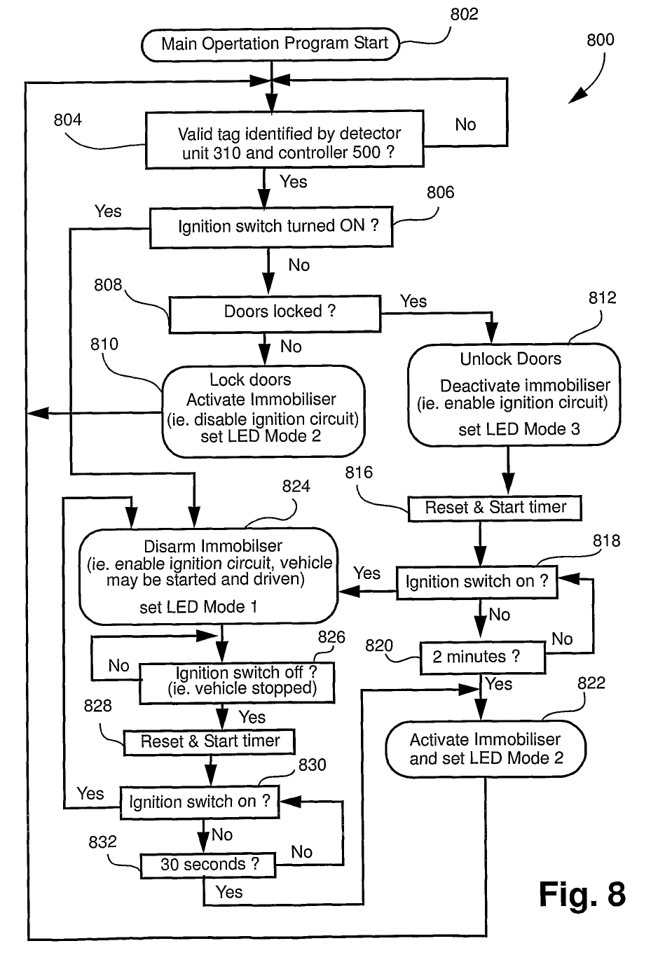

FIG. 8 shows a flowchart for a main operating program 800 of the system 300 to implement RFID access and immobiliser control and is operable once a single tag has been registered with the system 300. An entry point 802 distinguishes this program from that of FIGS. 6 and 7. The program 800, at step 804, checks for identification (ie. reading) of a validly registered tag. This is done by comparing the read tag identity with the list of registered tag identities stored in the controller 500. Where no valid tag is read, step 804 loops onto itself, continually check for such a tag.

When a valid tag is read, step 806 then checks if the ignition switch is turned on. In the present example of the program 800, such assumes that at least one of the immobiliser relays 536-540 is configured for disabling the ignition circuits of the motor vehicle regard less of the position of the ignition switch, which is usually operated by a turning of the traditional mechanical key. Where the ignition switch is found to be turned on in step 806, control passes to step 824, which will be discussed later.

Where the ignition switch is off, the status of the doors is then checked at step 808. If the doors are not locked, step 810 follows to lock the doors via the driver 542, to activate the immobiliser(s) via the relays 536-540 and to set the LED 336 to Mode 2 (see Table 1). Control then returns to step 804 to await identification of another valid tag.

If the doors are locked at step 808, step 812 follows to unlock the doors, thereby permitting entry to the vehicle, deactivates the immobilizer, and sets the LED 334 to Mode 3. Step 816 immediately resets and starts a 20 second timer. Whilst the timer is running, the status of the ignition switch is checked at step 818. If the ignition switch is turned on during the 20 second period, step 824 follows to disarm the immobilisers and to set the LED to Mode 1. At this stage, the vehicle engine may be started and the vehicle driven and operated normally. Step 826 follows to continually test for the ignition switch being turned off, this signifying a ceasing of operation of the vehicle. When the ignition switch is turned off, step 828 resets and starts a time which counts for a period of 30 seconds. During this period, at step 830, the position of the ignition switch is checked to determine if it is switched on. If it is switched on in this time period, control returns to step 824 confirming disarming of the immobilizers and permitting starting of the engine. This permits short term stopping of the vehicle (eg. accidental stalling) without a need to re-read a valid tag via the detector unit 310. Where the 30 second period expires without the ignition being switched on (eg. filling the vehicle with fuel), step 822 follows to activate the immobilizer functions and to set the LED 334 to Mode 2. Control returns from step 822 to step 804 to await reading of a validly registered tag.

If the 2 minute timer expires at step 820 without the ignition switch being turned on, also step 822 follows and the immobilisers are activated and the LED set to Mode 2. Control then returns to step 804 to await identification of another tag. The 2 minute period of step 820 permits a user to return to their vehicle, unlock the doors and attend to other short term activities prior to the immobilizer being automatically activated. Those activities may include stowing luggage or securing child occupants of the vehicle. Even if the user takes longer than 2 minutes and the immobilizer is activated, deactivation simply involves switching the ignition switch to on, and causing a reading of the user's validated tag via the detector unit 310 mounted upon the windscreen 102.

It will be apparent that the use of the RFID tag permits additional immobiliser functionality over and above that which may be afforded by a traditional key-type immobiliser system. Such functionality operates in concert with but in addition to any security afforded by the traditional key used in the ignition switch, even when such key is integrated with an RFID device and a proximity detector is adjacent the ignition switch.

With the system 300, it will be apparent, and is certainly intended, that the user need not carry upon them the traditional key to the vehicle. As an extreme, the key may be left in the ignition (although this may provoke forced entry by a thief or vandal). However, for short period departure from the cabin of the vehicle (eg. filling with fuel), the key could reasonably be left in the ignition and reading of a validly registered tag is necessary to re-start the vehicle. Most reasonably, the key, when not being used in the ignition, may secreted within the motor vehicle cabin to avoid a need to carry the same upon the person of a validated user. Even if an unauthorized person were to enter the vehicle and obtain the key, the immobiliser functions of the system 300 would prevent vehicle operation, until such time as a valid tag were brought into proximity of the detector unit 310.

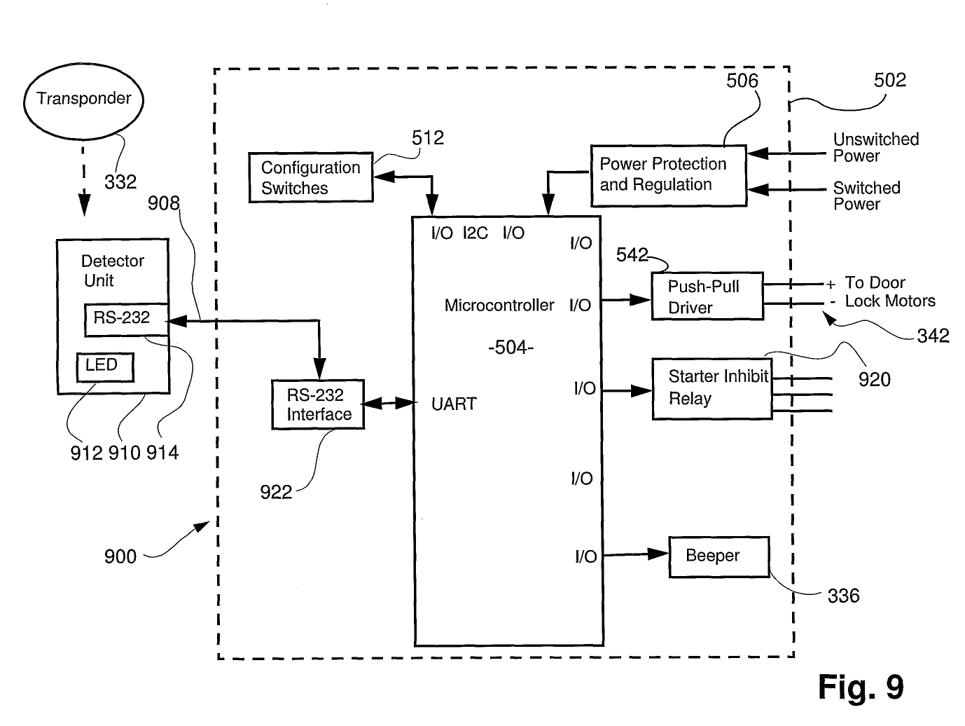

FIG. 9 shows an alternate version of a controller 900 that can be used in situations where immobiliser functionality is not essential or could be inconvenient. Here, the immobilizer functions are replaced by a starter inhibit function which, whilst being able to prevent starting of the vehicle, is subsequently not operable to disable an operating vehicle, thereby providing an alternate level of safety. In FIG. 9, each of the components shown having the same reference numeral as that in FIG. 5 has the same functionality and thus need not be described further. Certain features of FIG. 5 are omitted entirely providing for simpler manufacture, installation and operation. As such the arrangement of FIG. 9 may be used where only access control is desired through operation of the push-pull driver 542 for central locking operation and for starter inhibition. As seen in FIG. 9, the immobiliser relays of FIG. 5 are absent and are replaced by a starter inhibit relay 920. The relay 920 can be connected to the starter motor circuit of the vehicle to disable the starting operation. As such the relay 920 is distinct from the ignition circuits of the vehicle, and cannot be used to stop operation of a running engine. In some further implementations, the driver 542 need not be used.

In FIG. 9, a detector unit 910 is formed in a fashion similar to that of the unit 310 but in this implementation incorporating an RS-232 connection to a complementary device 922 in the controller 900. An RS-232 connection is used as such is single-channel, compared to the 4-channel RS-485 device of FIG. 5. A LED 912 is also provided in the detector unit 910 to substitute for operation of the LED 334 of FIG. 5.

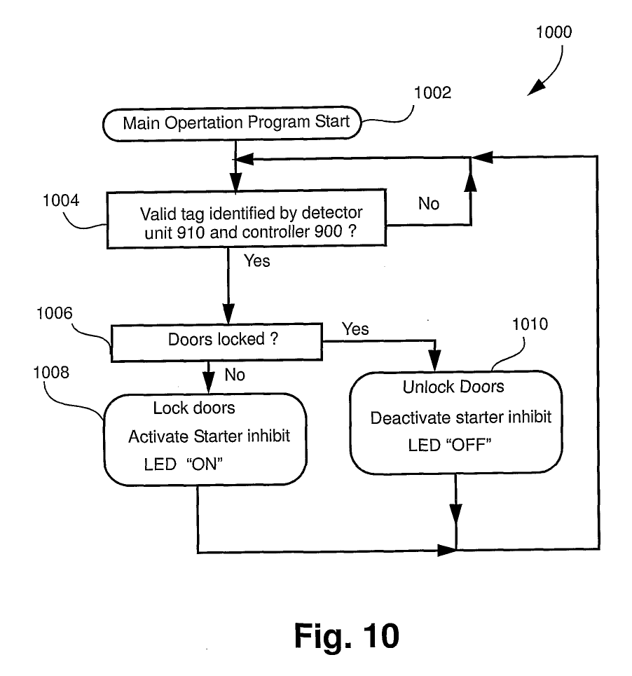

FIG. 10 shows a flowchart of a program 1000 representing the main control loop of the controller 900. After a program, entry point 1002, step 1004 tests whether a valid tag is identified by the detector unit 910 and the controller 900. If not, step 1004 loops back onto itself. Where a valid tag is identified, step 1006 tests if the doors of the vehicle are locked. If so, the doors are unlocked via the driver 542 and the starter inhibit relay 920 switched to deactivate starter inhibit. The LED 912 is turned off and the program loops back to step 1004. If the doors are not locked at step 1006, step 1008 follows to lock the doors via the driver 542 and to activate starter inhibit via the relay 920. The LED 912 is turned on. The program then loops back to step 1004. Programming of the controller 900 may be performed in a similar fashion to that of FIGS. 6 and 7.

The arrangement of FIG. 9 finds particular application in the operation of industrial machinery such as forklift trucks, tractors and other equipment that often do not have access doors by which a central locking arrangement may be used. For example, in a warehouse environment, only those staff licensed to drive a fork lift truck would have their corresponding tag validated for each fork lift. This would prevent an unlicensed person being able to operate such a machine. The same principle may be applied to other machinery, not necessarily transport machinery, but nevertheless operational, such a lathes, milling presses. Such machines traditionally have some form of user actuable switch to enable normal operation (equivalent to an ignition key of a vehicle) such that the proximity detection arrangement affords a further level of inhibition to operation by only those persons in possession of a validly registered proximity tag for that machine. It is further observed that the traditional user actuable switch may be electronic (such as a PIN pad) rather than key-based or a simple manual switch.

Whilst the described systems have been described primarily for automotive or machinery applications, such may be readily adapted for domestic and commercial access control of buildings and the like. Typically, a cut down build of the controller 500, like the controller 900, will be suitable for this purpose, allowing control of a standard strike plate electrically controllable lock. Interfacing with a domestic intruder alarm system may also be required. Overall operation and functions such as tag learning will be similar to the primary automotive application. The unit for example may be installed in a sheltered situation, or within a weatherproof enclosure. Powering will typically be via a mains-derived low voltage DC power supply such as a plug pack.

The systems described may be further enhanced through the use of active tag devices and complementary reader-detector units. Active tag technology permits longer range detection (eg. 2 metres or more). Further, in the controller 500, the ability to connect 4 detector units to the multiplexer 518 provides for a mixing of both passive and active technologies in a single installation through the use of corresponding detector units and tags.

The proximity detection arrangement may be further enhance in its security effect through the use of encryption of the identity code during conveyance from the tag to the detector unit. Such tags may accord to the MIFARE standard recently used in the finance industry. The Philips HITAG™ transponder chip and reader may also be used to increase security.

Further, whilst the proximity tags may conveniently worn upon the user (eg. FIG. 2), such may also be carried in a traditional manner, such as a credit card sized tag, or affixed to some convenient portable device, such as a cellular mobile telephone. In any of these forms, the proximity tag may be used to provide further levels of immobilization for disablement control over that which may or may not be fitted top a vehicle or machine. In a further implementation, glass transponder tags may be subcutaneously injected into the user (in a manner similar to the tagging of domestic pets).

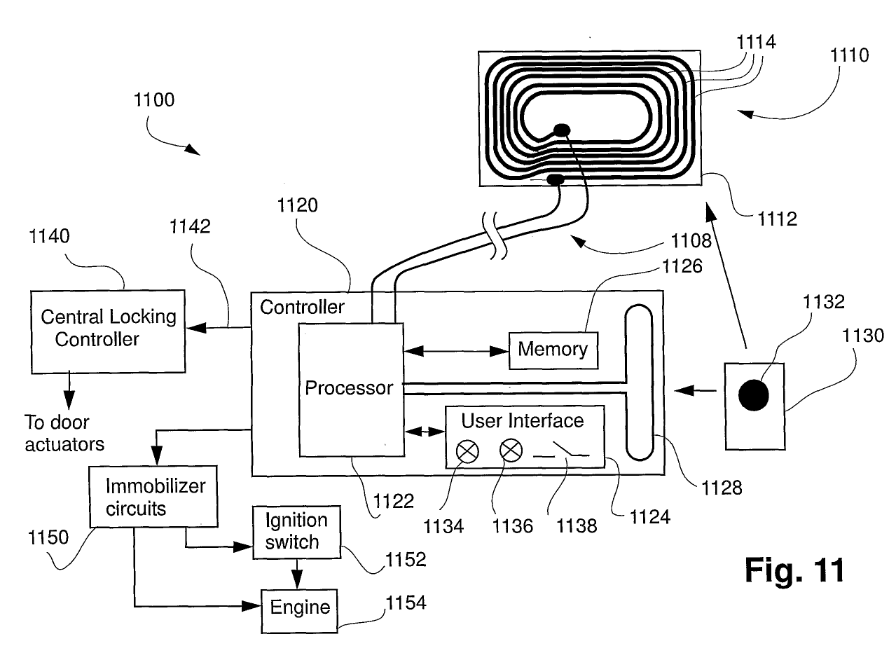

As seen in FIG. 11, an access control system 1100 is illustrated and which may be configured within the motor vehicle 100 to provide access from the exterior of the motor vehicle 100 to the cabin of the motor vehicle 100. The system 1100 has a controller module 1120 to which a flat 1110 connects via a coupling cable 1108. The flat antenna 1110 is formed of a flexible substrate 1112, upon which is a conductive track 1114 that traces a loop about the substrate 1112 thereby forming a loop antenna structure. The antenna 1110 couples to a proximity detector 1122 within the controller 1120.

The controller 1120 further includes a memory 1126 into which is programmed those codes that can be read by the proximity detector 1122 and which are authorized to provide access to the motor vehicle 1100. When the proximity detector 1122 reads a code from a proximity device (eg. 1132) via the antenna 1110, the proximity detector 1122 compares that code against a list of codes contained within the memory 1126. If the read code matches one of the codes contained within the memory 1126, the proximity detector 1122 outputs a control signal 1142 to a central locking controller 1140 associated with the motor vehicle 1100. The central locking controller 1140 then deactivates various door locks 104 (seen in FIG. 1) to enable access to the cabin of motor vehicle 1100. An output is provided to immobilizer circuitry 1150. With this the immobilizer circuits 1150 of the vehicle can be armed and disarmed thereby influencing operation of an ignition switch 1152 and the engine 1154 of the vehicle. As seen in FIG. 11, the immobilizer may be used to separately disarm each of the ignition switch 1152 and the engine 1154.

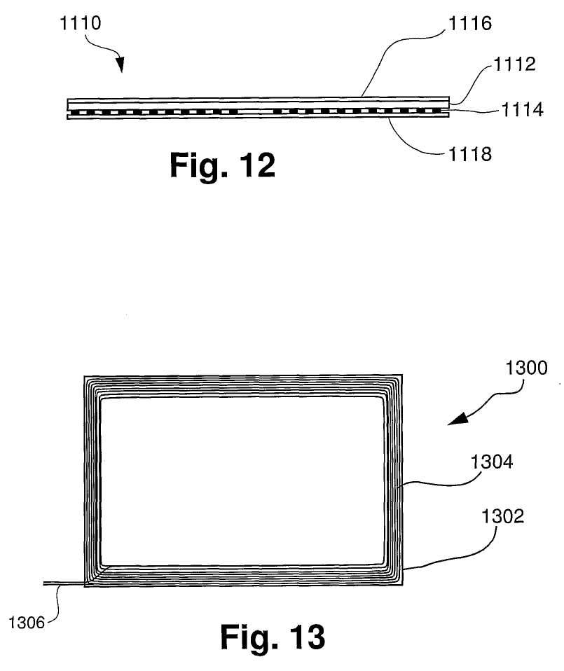

As seen in FIG. 11, the flat antenna 1110 includes the track 1114 formed upon the flexible substrate 1112 which may, for example, be manufactured to thickness of about 0.5 mm. The substrate 1112 may be any suitable material such as polyimide, Mylar, Teflon, or polyester. Desirably, the substrate 1112 is transparent thereby making the antenna 1110 less visually obtrusive. The track 1114 may be formed as a copper printed circuit upon a face of the substrate 1112. As perhaps better seen in FIG. 12, attached to the substrate 1112 is a double sided adhesive layer 1116 which provides for adhesion to the substrate 1112 and also to the inside of a fixed glass panel, such as the windscreen 102 of the motor vehicle 1100. A further adhesive layer 1118 is provided against the outer surface of the antenna track 1114 and operates as a physical protection layer for the track 1114 from the inside of the motor vehicle 1100. The number of loops formed by the track 1114 will vary depending on the overall dimensions of the flat antenna 1110, the operating frequency of the scanning process performed by the controller 1120, and the gain of the RF amplifier within the proximity detector 1122. The flat antenna 1110 desirably has a size approximating that of a motor vehicle registration label (ie: about 100 mm×60 mm). In such instances the number of loops may number 15-20. For a smaller size (eg: about 80 mm×50 mm) the number of loops may be 20-25.

The arrangement of FIG. 11 provides convenient use of proximity technology for access to a motor vehicle through the use of a flat antenna 1110 which may be positioned upon a fixed glass panel. As such a user of the motor vehicle 100, when approaching the motor vehicle 100 may merely pass their proximity device, upon their hand 200, across the windscreen 102 and adjacent the antenna 1110 to disable the central locking feature of the motor vehicle 1100.

In the vehicular deployment, one flexible antenna 1110 is typically mounted on the vehicle windscreen and is used for access control, whilst another antenna 1128 may be located on or near the steering column can be used for control of a vehicle immobilizer. Alternatively, a single antenna, such as the antenna 1110 may be used for both access and immobilizer control functions. The controller 1120 is installed in a protected location within the passenger cabin, typically behind the dashboard. Optional vehicular installations may provide only the access control or immobilizer functions. The system 1100 may further be adapted for non-vehicular applications such as residential premises access control or hotel room access control.

FIG. 13 shows a flexible access reader antenna 1300 is formed as a flexible printed wiring board (PWB) having conductive tracks formed thereon, this figure better depicting the density of conductive tracks within a useful implementation. The antenna 1300 is configured for adhering to an inside of the motor vehicle windscreen or window, or at a location on other curved non-metallic surfaces or within curved or irregularly shaped structures. The antenna 1300 may be similarly formed for appropriate placement about the cabin of the motor vehicle, or alternatively may be formed of a traditional wire loop antenna commonly used in remote access arrangements.

Traditional wire loop antennae used in radio frequency identification (RFID) arrangements have certain electrical and electromagnetic characteristics that provide for reliable operation with existing transponders, such as those noted above and as used in some of the arrangements discussed above. In addition to emulating those characteristics, the following characteristics are also desired for the flat flexible antenna:

(i) to enable practical and unobtrusive operation, the present inventor has found that a size and shape approximating that of a vehicle registration label, as well as a substantially flat configuration will permit unobtrusive installation when adhered to the inside of a vehicle windscreen;

(ii) the antenna should be sufficiently flexible to adapt to the internal contours of a vehicle windscreen, thereby enabling reliable adhering thereto; and

(iii) the antenna should project a uniform magnetic field as far as practicable, within overall antenna size constraints. For this, the antenna aperture must be maximized. Such implies that the coil windings should be concentrated as far as practicable toward the periphery of the antenna, so that the maximum practicable area is included by the coil.

In addition to size and shape, a number of constraints are desirably considered in the implementation of the flat flexible antenna:

(iv) the antenna should be aesthetically acceptable to allow installation on the inside of a passenger vehicle windscreen, within view of the vehicle occupants;

(v) a wired connection is to be made to the antenna, with the wiring being as unobtrusive as practicable without compromising antenna electrical characteristics;

(vi) the antenna and wiring should be securely attached to the vehicle, generally using adhesive;

(vii) detuning of the antenna by nearby metallic and dielectric material should be considered in the design of the antenna and tuning processes of the system 500; and

(viii) the antenna should maintain desired operating characteristics over the full operating temperature range of the system. In particular, inductance of the coil track should not vary excessively over the temperature range.

The arrangement of a preferred antenna 1300 involves a number of compromises when compared with traditional antenna formed of a coil wound with enamelled copper wire. The following issues require consideration:

(ix) the use of planar copper tacks, rather than wire, can reduce the average area of the coil, for a given outer diameter, as the tracks are of finite width. This is determined by PWB manufacturing processes and additional requirements to ensure reliable operation. As such the bulk of the tracks cannot be concentrated at the coil periphery, thereby reducing the aperture of the antenna 1300.

(x) minimizing the reduction of the antenna aperture requires the use of PWB tracks which are as thin as practicable. Such may increase antenna resistance (and thus reduce quality factor) when compared with the equivalent traditional wound coil antenna;

(xi) due to the planar nature of the PWB tracks, skin effect must be taken into account at the operating frequency of the antenna (approx. 125 kHz), and may impact on the arrangement of the PWB trackwork;

(xii) the effects of stray inductance and capacitance of the PWB trackwork and connecting wiring should be taken into account;

(xiii) stray capacitive and inductive coupling between the antenna and the vehicle windscreen body should be considered; and

(xiv) shielding of the generated magnetic field by the motor vehicle windscreen and bodywork must be considered in the antenna design. In particular, the presence of films on or within the vehicle windscreen structure (eg. for solar radiation reduction) must be taken into account.

Given these requirements, compromises and effects, an exemplary implementation of the antenna 1100 is provided in FIG. 13 which shows an antenna 1300 formed by a substantially rectangular flexible Printed Wiring Board (PWB) substrate 1302 having with an antenna coil formed by a concentric spiral of a PWB copper track 1304. A 2-wire connection 1306 connects to respective ends of the concentric track 1304. The substrate 1302 is planar and has dimensions of 80×53 mm and upon which is formed a coil track 604 of between 20-100 turns. The coil preferably has track width and separation to provide a coil width of between about 10-20 mm extending inwardly from the periphery of the substrate 602. The PWB substrate 602 is typically about 0.5-1.0 mm in thickness and is desirably protected using a suitably flexible thin plastics material such as Mylar™, and is adhered to the inside of the vehicle windscreen using, for example, double-sided transparent adhesive tape. Like the arrangement of FIGS. 11 and 12, the antenna 1300 may also be provided with a protective backing layer, for example in the form of a single-sided adhesive tape. The specific number of turns and size of the track will be determined by operational parameters and may vary significantly with different types of tags.

The antennae 1100/1300 provides near-field magnetic coupling between the system 1120 and the transponder 1132, at a relatively low frequency (about 125 kHz). Significantly, such antennae must operate to couple magnetic energy from the system to the transponder (tag) and further to receive the electromagnetic return from the transponder (tag).

As such the antenna 1100/1300 contrasts traditional planar antennae. There exist many examples of planar antennae implemented in the form of metallic strip or tracks formed on a surface (eg. glass), typically in automotive environments. The antenna are generally used for far field (plane wave) electrical field coupling of relatively high frequency signals, ranging from AM (eg. 530-1600 kHz) and FM (eg. 90-108 MHz) radio through to cellular telephone operation (eg. 900-1900 MHz).

The antennae 1100/1300 also contrast antennae typically found in wireless identification tags (transponders). Such tag antennae are typically implemented in the form of loops of PWB trackwork to form a multi-turn coil for near-field magnetic coupling, but not in the form of or upon a flexible substrate adapted to adhere to a surface and to both transmit and receive magnetic energy.

In a further implementation, the flexible flat antennae 1100/1300 may be used in the system 300 of FIG. 3. In such an implementation, the flat antenna may be substituted for the traditional wire loop antenna typically found in the detector module 314. That wire loop antenna may physically remain within the module 314, but its connections to reader and decoder circuits substituted with connections from the antennae 1100/1300. Where desired, the existing wire loop antenna may remain operationally connected, thereby implementing a twin antenna arrangement, similar to that shown in FIG. 11.

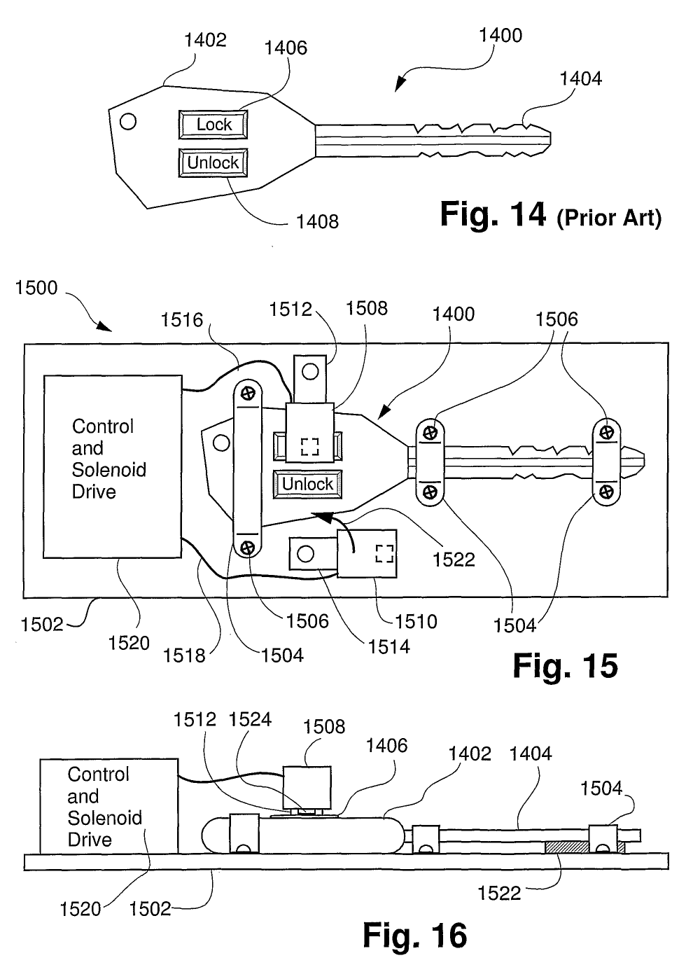

FIG. 14 shows a prior art motor vehicle key 1400 of the type commonly used in motor vehicles manufactured over the past 5 years or so which have both a central locking facility and a vehicle immobilization facility. As seen, the key 1400 includes a body 1402 connected to a traditional key shank 1404 which is shaped so as to complement a key lock receptacle within the motor vehicle. The key 1400 typically includes two switches 1406 and 1408 actuable by the user to either lock or unlock the doors of the motor vehicle. Not illustrated in FIG. 14 but generally contained within the body 1402, the key 1400 typically includes an immobilization chip or other circuitry that is operative to disable motor vehicle immobilization. In some instances this occurs when the key 1400 is brought near or inserted into the ignition of the motor vehicle. Upon removing the key 1400 from the ignition, the traditional immobilization system is then activated effectively preventing “hot wiring” of the motor vehicle. This type of key is the type of key mentioned above and which can often cost approximately AU$250-300 in order to replace or to obtain a spare key. Further, such keys cannot be readily obtained from general retail outlets, but most often must be ordered from the particular motor vehicle manufacturer, generally through a local dealer.

FIGS. 15 and 16 illustrate a further arrangement whereby remote access using an electronic tag may be obtained to a motor vehicle whilst at the same time using the remote tag as in the arrangements discussed above, to implement an immobilizing function within the motor vehicle.

In the arrangement of FIGS. 15 and 16, the motor vehicle owner is required to purchase an additional key 1400 (or perhaps use their spare key if such exists) whereupon the key 1400 is securely mounted upon a plate or substrate 1502. The plate or substrate 1502 may be part of a plastic box or like housing which is desirably mounted at a convenient location within the motor vehicle, generally near the ignition. The key 1400 is secured to the substrate 1502 using, in the illustrated arrangement, a number of straps 1504 each secured to the substrate 1502 using a pair of screws 1506. As illustrated in FIG. 16, the shank 1404 of the key 1400 may be supported by a filler portion 1522 so that the key 1400 is prevented from any movement relative to the substrate 1502.

Also configured upon the substrate 1502 is a control and solenoid drive unit 1520. This unit is preferably driven by a detector module 314 such as that illustrated in FIG. 4 (and used in the arrangement of FIG. 5). In this fashion, a user of the motor vehicle may approach the motor vehicle whilst wearing a tag 332 and by which the presence of the tag is detected by the detector module 314. The detector module 314 can thereby output one or more control signals to the control and solenoid drive unit 1520 which is operable to interpret the signals received from the tag detector module 314 and to provide drive signals to a pair of micro-solenoids 1508 and 1510. The micro-solenoids 1508/11510 are each positionable above a corresponding one of the switches 1406 and 1408 of the key 1400.

As seen in FIG. 15, each of the micro-solenoids 1508 and 1510 is supported by a pivotable rigid support 1512, 1514 such that a solenoid piston 1524 of the corresponding micro-solenoid 1508 is normally positioned immediately above the corresponding switch 1406. As a consequence, when an actuation signal is received from the control and solenoid drive unit 1520, the micro-solenoid 1508 is able to actuate, extending the piston 1524 to contact the button 1406 and thereby cause the key 1400 to perform the appropriate locking (or unlocking) action, as the case may be.

Each of the mounting portions 1512 and 1514 for the corresponding micro-solenoid is able to be pivotally adjusted so that the micro-solenoid can swing away from a position above the corresponding key switch 1406, 1408. As seen in FIG. 15, the micro-solenoid 1510 is shown in the non-operative “swing away” position which may be used to provide for in placement, and possible removal, of the key 1400 from under the strap restraints 1504. It would be appreciated from FIGS. 15 and 16 that the micro-solenoid should be configured to exert sufficient force upon the corresponding switch so as to cause actuation of the switch. The supports 1512 and 1514 accordingly must be of sufficient strength so that they may be moved from the pivotal non-operative position into the operative position and yet securely support the micro-solenoid above the key 1400 so that sufficient force may be applied downwardly upon the switch.

The arrangement of FIGS. 15 and 16 finds specific use in modern motor vehicle systems which often incorporate the CAM-BUS system which can include proprietary configurations not readily accessible to retrofitting by after-market equipment suppliers. Importantly, using the arrangement of FIGS. 15 and 16, after-market suppliers can fit the arrangement to CAM-BUS vehicles without connection to the CAM-BUS system. This avoids possible warranty problems. Further the additional cost of the key 1400 is often offset be the saving on installation cost and proprietary equipment needed to couple to CAM-BUS. In this fashion, the use of the “spare” key 1400 provides for electronic remote access to that system whilst at the same time affording secure access and immobilization of the motor vehicle using an electronic tag easily wearable by the user of the motor vehicle. The arrangement of FIGS. 15 and 16 is advantageous in that the key 1400 requires no adaptation and only the physical placement of the key upon the substrate 1502. The immobilizer functionality of the arrangement of FIGS. 15 and 16 arises generally through the immobilizing function of the key 1400 being associated with the locked status of the doors. That is when the doors are locked (for example after exiting the vehicle) the immobilizer is activated. When the doors are unlocked (for entry) the immobilizer is active until disable by the key 1400 being brought near or inserted into the ignition. It follows therefore that with the arrangement 1500, detection of a valid tag can both unlock the doors (via activation of the button 1408) and disarm the immobilizer, (via the position of the key 1400). Insertion of a key into the ignition switch is nevertheless necessary to start the vehicle.

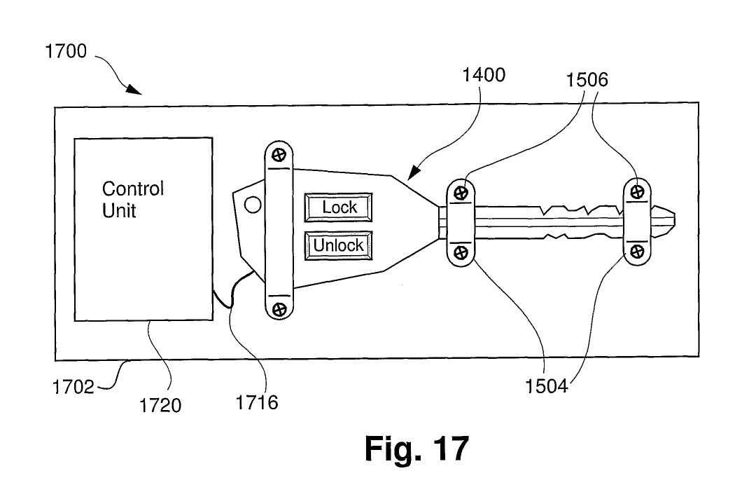

In the arrangement of FIG. 17, the key 1400 is again secured to a substrate 1702 (although in this arrangement, the strength of securing is not as important). In the arrangement 1700 of FIG. 17, a control unit 1720 is provided which has a direct electrical connection 1716 to the electronics contained within the key 1400. In this configuration, an after market installer of such a system can directly access the electronics of the key 1400 so as to obviate the need for the micro-solenoids and their drive as in the arrangement of FIGS. 15 and 16. This arrangement has the advantage of a more reliable electronic connection between the control unit and the actuation of the key 1400.

However this is associated with the attendant labor cost of electronically accessing the key and the fact that the key 1400 may not subsequently be usable in its own right in a traditional form. The arrangement of FIGS. 15 and 16 provides for the key to be reused in its original form and for relatively quick installation. However, such arrangements are complicated by the electromechanical nature of the micro-solenoids 1508 and 1510. Like the arrangement of FIGS. 15 and 16, the control unit 1720 of the arrangements 1700 can directly connect to the detector unit 314. As previously described, the detector unit 314 may be operatively coupled where appropriate, to a flat flexible antenna 1110/1300 as shown in FIGS. 11 and 13.

With the key 1400, insertion into the ignition of the motor vehicle is not always essential to cause for the immobilization to be operative. Most often, immobilization can occur when the key 1400 is sufficiently proximate to immobilization detection circuits often associated in the dashboard of such motor vehicles. Accordingly, when using the arrangements of FIGS. 15 to 17, the container in which the relevant arrangements are formed can be positioned behind the dashboard in a location near the ignition switch.

A number of specifically useful arrangements arise from the foregoing disclosure, some example of which include:

(i) An antenna comprising: a flexible substrate; an antenna coil formed as a printed wiring track upon a first face of said substrate and adapted for near-field magnetic coupling to an identity transponder device; at least one adhesive layer adapted to adhere said substrate to a surface.

(ii) An antenna according to (i) further comprising a protective layer adapted to cover said first face to protect said track.

(iii) An antenna according to (i) or (ii) wherein said one adhesive layer comprises a double-sided adhesive tape adhered to a second face of said substrate.

(iv) An antenna according to (i), (ii), or (iii) wherein said protective layer comprises a single-sided adhesive tape adhered to said first face.

(v) An antenna according to any one of the above wherein said substrate is substantially rectangular and has dimensions of between about 80 mm×50 mm and 100 mm×60 mm.

(vi) An antenna according to any one of the above wherein said track forms said coil having between 15 and 100 turns.

(vii) A method of forming an antenna used to obtain access to apparatus, said method comprising the steps of: providing a flexible substrate; forming an antenna coil as a printed wiring track upon a first face of said substrate, said coil being adapted for near-field magnetic coupling to an identity transponder device; providing at least one adhesive layer to said substrate; and adhering said substrate via said one adhesive layer to a surface of said apparatus.

(viii) A method according to (vii) wherein said apparatus comprises one of a motor vehicle and a building, and said surface comprises a window thereof.

(ix) A method according to (viii) wherein said window is a windscreen.

(x) A method according to (vii) wherein said apparatus is a building and said surface comprises one of a substantially magnetically transparent door or a wall lining.

(xi) A method according to any one of (vii) to (x) wherein said one adhesive layer is provided to a second face of said substrate, said method further comprising providing a further adhesive layer to said first face of said substrate to protect said track.

(xii) An access system for providing secure access to apparatus, said system comprising: at least one antenna according to any one of (i) to (vi) and adapted to be adhered to an external substantially magnetically transparent surface of the apparatus; and a controller locatable within the apparatus and coupled to each of said antenna and a locking system associated with entry to the apparatus, said controller including a proximity detection arrangement configured, in association with said one antenna, to detect a coded value of a proximity transponder tag when such is brought into proximity with said antenna adjacent said substantially magnetically transparent surface, and to compare the detected coded value with a retained list of such values to thereby enable or disable operation of the locking system.

(xiii) A system according to (xii) wherein said apparatus comprises a motor vehicle and said surface comprises a widow or windscreen thereof.

(xiv) A system according to (xiii) wherein said locking system comprises a central locking system of said motor vehicle, said system further comprising a further antenna arranged within a cabin of said motor vehicle and connected to said controller and adapted to detect a continued presence of said proximity transponder tag within said cabin to disable an immobilizer system associated with said motor vehicle.

(xv) A system according to (xii) wherein said apparatus comprises a building having and access door, and said one antenna being affixed to said surface being one of said door or a wall panel substantially adjacent thereto.

(xvi) A method of programming a new transponder identity to an access control system, said method comprising the steps of: (a) providing an antenna according to any one of (i)-(vi) adhered to a surface formed of substantially magnetically transparent material and connecting said antenna to said access control system to thereby enable actuation of said system when a validly programmed transponder tag is brought into proximity therewith; (b) detecting with said antenna and system a proximal location of a prior valid transponder tag for an extended period of time in excess of normal actuation of said system for access control to thereby cause said system to enter a learning mode; (c) after entering said learning mode detecting with said antenna the proximal presence a non-validated transponder tag whose identity is desired to be learnt by said system; (d) after said non-validated tag is detected, provisionally learning the new identity of said non-validated tag; and (e) then detecting with said antenna the prior valid transponder tag for a third predetermined period of time to thereby validate the learning of new identity in said system.

(xvii) A method according to (xvi) wherein step (d) comprises retaining said provisionally learnt identity in volatile memory of said system and step (e) comprises transferring said learnt identity from said volatile memory to non-volatile memory of said system.

(xviii) A method according to (xvi) or (xvii) wherein said extended period comprises a first predetermined period of time, step (c) comprises detecting said non-validated transponder tag for a second predetermined period of time and step (e) comprise detecting said prior valid transponder tag for a third predetermined period of time.

(xix) A method according to claim (xviii) wherein after steps (b) and (d) a fourth predetermined period of time is awaited to enable detection of said non-validated and said prior valid transponder tags respectively.

(xx) An flat antenna having a flexible substrate substantially as described herein with reference to FIGS. 4 and 5 or FIGS. 4 and 6 of the drawings.

In a generic implementation, the present disclosure affords a system in which a proximity identification device is able to be worn or carried by a user and in which the device is configured to permit operational access to a facility or a machine and to at least disarm an immobilization function associated with the facility or machine. The facility may be a building and the access may be through an electronically lockable door. The immobilization function may be an alarm system associated with the building or related to equipment within the facility. The machine may be a motor vehicle and the access afforded by disabling a central locking system thereof. The immobilization function may be one or more arrangements that prevent operation of the motor vehicle.

### INDUSTRIAL APPLICABILITY

The present invention finds application in the securing and disarming operation of motor vehicles, other machines, private dwellings and commercial premises whilst affording convenient non-contact secure entry.

The foregoing only describes only a number of embodiments of the present invention and modifications can be made thereto with departing from the scope of the present invention.

(Australia Only) In the context of this specification, and claims, the word “comprising” means “including principally but not necessarily solely”. Variations of the word “comprising” such as “comprise” and “comprises” have correspondingly varied meanings.

1. A user operable machine comprising:
a switch arrangement actuable by at least user manipulation thereof and arranged to enable operation of said machine;
at least one immobiliser arrangement connected with said switch arrangement and configured to selectively inhibit or permit operation of said machine via said switch arrangement; and
a proximity detection arrangement associated with said machine and adapted for detection and reading of at least one proximity identification device carried or worn by a user of said machine, said proximity detection arrangement being independent of said switch arrangement and any actuator thereof, whereby reading of a validly registered identification device by said proximity detection arrangement provides for a disarming of said immobilizer arrangement to thereby permit is operation of said machine.

2. A machine according to claim 1 wherein said switch arrangement comprises one of a keyed switch, an electronic switch, and a mechanical switch.

3. A machine according to claim 2 wherein said switch arrangement has associated therewith a further proximity detection arrangement configured to detect a proximity device associable with actuation of the switch arrangement.

4. A machine according to claim 1 wherein said machine is selected from the group consisting of a motor vehicle, a fork lift truck, a tractor, an industrial fabrication machine.

5. A machine according to claim 1 wherein said one immobiliser arrangement comprises a starter inhibit arrangement configured to prevent starting of said machine.

6. A machine according to claim 1 wherein said one immobiliser arrangement comprises an immobiliser adapted to at least one of inhibit starting of said machine and to cause cessation of operation of said machine.

7. A method of operating a vehicle, said method comprising the steps of:
accessing the vehicle using a proximity tag device;
disarming at least one immobiliser arrangement of said vehicle using said proximity tag device; and
enabling a starter of said vehicle using a starter device of the vehicle.

8. A method according to claim 7 wherein said starter comprises an ignition switch of said vehicle and said starter device comprises an actuator of said ignition switch.

9. A method according to claim 8 wherein said actuator comprises one of a mechanical or electronic key device.

10. A method according to claim 7 further comprising monitoring at least one time period associated with performance of one of said steps to at least re-arm said immobiliser arrangement to prevent operation of said vehicle.

11. A method according to claim 10 wherein said time periods are selected from a group consisting of:
(i) a period after unlocking of doors of said vehicle;
(ii) a period after the starter of the vehicle is disabled.

12. A system to permit access and operation of a machine, the machine having a switch arrangement actuable by at least user manipulation thereof and arranged to enable operation of the machine, and at least one immobilizer arrangement connected with the switch arrangement and configured to selectively inhibit or permit operation of the machine via the switch arrangement, said system comprising:
a proximity detection arrangement associable with the machine and adapted for detection and reading of at least one proximity identification device carried or worn by a user of the machine; and
a control arrangement responsive to detection by the proximity detection arrangement of a valid device to thereby disarm the immobilizer arrangement; said proximity detection arrangement being at least operationally independent of the switch arrangement and any actuator thereof.

13. A system according to claim 12 wherein said control arrangement comprises an additional actuator of the switch arrangement and apparatus configured to cause selective actuation of electronic control functions associated with said additional actuator,

14. A system according to claim 13 wherein said apparatus comprises components configured to physically actuate the electronic control functions.

15. A system according to claim 13 wherein said apparatus comprises at least a connection to electronically actuate the electronic control functions.

16. The machine according to claim 1 wherein said proximity detection arrangement comprises an antenna for detecting the proximity detection device, the antenna comprising:
a flexible substrate;
an antenna coil formed as a printed wiring track upon a first face of said substrate and adapted for near-field magnetic coupling to an identity transponder device; and
at least one adhesive layer adapted to adhere said substrate to a surface.

17. The invention according to claim 16 further comprising a protective layer adapted to cover said first face to protect said track.

18. The invention according to claim 16 wherein said one adhesive layer comprises a double-sided adhesive tape adhered to a second face of said substrate.

19. The invention according to claim 16 wherein said protective layer comprises a single-sided adhesive tape adhered to said first face.

20. The invention according to claim 16 wherein said substrate is substantially rectangular and has dimensions of between about 80 mm×50 mm and 100 mm×60 mm.

21. The invention according to claim 16 wherein said track forms said coil having between 15 and 100 turns.

22. A system to permit access and operation of a motor vehicle, the motor vehicle having an ignition switch arrangement actuable by at least user manipulation thereof with an ignition key and arranged to enable operation of the motor vehicle, and at least one immobilizer arrangement connected with the ignition switch arrangement and configured to selectively inhibit or permit operation of the motor vehicle at least via the ignition switch arrangement, said system comprising:
a proximity detection arrangement associable with the motor vehicle and adapted for detection and reading of at least one proximity identification device carried or worn by a user of the motor vehicle, said proximity detection arrangement comprising an antenna coupled to a detector for decoding an identity of the device;
a control arrangement responsive to detection by the proximity detection arrangement of a proximity device and operative to check a validity of the identity of the proximity device and, where valid, to thereby disarm the immobilizer arrangement to thereby permit operation of the motor vehicle by actuation of the key within the ignition switch.

23. A system according to claim 22 wherein said proximity detection arrangement is at least operationally independent of the ignition switch arrangement and the key actuator thereof

24. A system according to claim 22 wherein said control arrangement operatively couples to a central locking system of the motor vehicle to thereby enable entry to a cabin of the vehicle by the user.

25. A system in which a proximity identification device able to be worn or carried by a user in which the device is configured to permit operational access to a facility or a machine and to at least disarm an immobilization function associated with the facility or machine.

25. (canceled)

26. A system according to claim 12 wherein said proximity detection arrangement comprises an antenna for detecting the proximity detection device, the antenna comprising:
a flexible substrate;
an antenna coil formed as a printed wiring track upon a first face of said substrate and adapted for near-field magnetic coupling to an identity transponder device; and
at least one adhesive layer adapted to adhere said substrate to a surface.
